(19) United States
(12) Patent Application Publication
(10) Pub. No.: US 2015/0346669 A1
(43) Pub. Date: Dec. 3, 2015

(54) PRINTING MEDIUM SUPPLYING APPARATUS AND IMAGE FORMING APPARATUS HAVING THE SAME

(71) Applicant: Samsung Electronics Co., Ltd., Suwon-si (KR)

(72) Inventors: Ho-Young CHOI, Suwon-si (KR); Jin Soo LEE, Yongin-si (KR)

(73) Assignee: Samsung Electronics Co., Ltd., Suwon-si (KR)

(21) Appl. No.: 14/724,189

(22) Filed: May 28, 2015

(30) Foreign Application Priority Data
Jun. 3, 2014 (KR) 10-2014-0067655

(51) Int. Cl. G03G 15/00

(52) U.S. Cl. CPC G03G 15/6529

(57) ABSTRACT

An image forming apparatus supplies a printing medium to a development apparatus upon single-sided printing or double-sided printing. The image forming apparatus may include a printing medium supplying apparatus provided such that various kinds of printing media are compatible. Accordingly, the single-sided printing and the double-sided printing can be easily performed regardless of the size of the printing medium.

### CROSS-REFERENCE TO RELATED APPLICATIONS

This application claims the priority benefit of Korean Patent Application No. 10-2014-0067655, filed on Jun. 3, 2014 in the Korean Intellectual Property Office, the disclosure of which is incorporated herein by reference.

### BACKGROUND

1. Field

Embodiments relate to an image forming apparatus, and more particularly, to an image forming apparatus in which various kinds (types) of printing media are compatible.

2. Description of the Related Art

Image forming apparatuses are each an apparatus for forming an image on a printing medium according to an input signal, for example, a printer, a duplicator, a facsimile, and a multi-functional device implemented by integrating functions thereof.

Such image forming apparatuses are provided with a printing medium supplying apparatus for supplying a printing medium. Conventionally, the printing medium supplying apparatus picks up one of stocked printing media to supply the printing medium to a development apparatus.

The image forming apparatus may be provided to enable single-sided printing and double-sided printing. Upon the single-sided printing and the double-sided printing, the printing medium is supplied to the development apparatus according to a certain reference line such that an image aligned on the printing medium can be formed.

However, reference lines of supply of the printing medium in the printing medium supplying apparatus and supply of the printing medium in the double-sided printing apparatus are different from each other.

### SUMMARY

In an aspect of one or more embodiments, there is provided an image forming apparatus having an improved structure in which various kinds of printing media are compatible.

In an aspect of one or more embodiments, there is provided an image forming apparatus which includes: a printing medium supplying apparatus provided with a printing medium aligning apparatus; and a development apparatus to receive a printing medium from the printing medium supplying apparatus and form an image, wherein the printing medium aligning apparatus includes a stationary guide unit to guide one end of the printing medium; and a variable guide unit to move with the stationary guide unit or independently move with respect to the stationary guide unit to guide the other end of the printing medium.

The variable guide unit may be relatively movable with respect to the stationary guide unit.

The printing medium aligning apparatus may include a pinion member, which is rotatably provided; and a pair of rack gear members having a stationary rack gear member at which the stationary guide unit is disposed and a variable rack gear member at which the variable guide unit is disposed, and interlocked with the pinion member.

The variable guide unit may include a fixing member provided to be fixed to the variable rack gear member, and the variable rack gear member may include a plurality of coupling grooves provided such that a position to which the fixing member is fixed varies according to a kind of the printing medium.

The printing medium supplying apparatus may include a first operation mode and a second operation mode, and the printing medium aligning apparatus may be disposed such that centers of the stationary guide unit and the variable guide unit pass through a first reference line in the first operation mode, and such that the variable guide unit may independently operates from the stationary guide unit and the centers of the variable guide unit and the stationary guide unit coincide with the first reference line or pass through a second reference line spaced apart from the first reference line in the second operation mode.

The first operation mode may include a single-sided printing mode of the printing medium, and the second operation mode may include a double-sided printing mode of the printing medium.

The printing medium aligning apparatus may be formed to vary a position of the second reference line according to a kind of the printing medium.

The printing medium supplying apparatus may include at least one pick-up roller configured to sequentially supply the stacked printing media to the development apparatus and disposed such that the center of the printing medium passes through the first reference line.

The image forming apparatus may further include a double-sided printing apparatus to align a side surface of the printing medium to a fixed side reference line spaced apart from the first reference line and to supply the printing medium to the development apparatus to form an image on a rear surface of the printing medium having one surface on which the image is formed in the development apparatus.

The double-sided printing apparatus may include a skew unit configured to diagonally move the printing medium along the side reference line to align the side surface of the printing medium to the side reference line.

The skew unit may include an aligning roller configured to be inclined toward the side reference line at a predetermined angle such that the printing medium is moved diagonally with respect to a progress direction.

Provided that a distance between the aligning roller and the first reference line is D, when a width (W) of the printing medium is smaller than 2 D, a position of the second reference line may be varied such that a distance between the second reference line and the aligning roller becomes D.

The second reference line may be disposed between the first reference line and the side reference line.

In an aspect of one or more embodiments, there is provided an image forming apparatus which may include: a main body; a development apparatus provided at the main body to form an image on a printing medium; and a printing medium supplying apparatus to supply a printing medium to the development apparatus such that a center of the printing medium is supplied along a first reference line in a first operation mode, and the center of printing medium coincides with the first reference line or is supplied along a second reference line spaced apart from the first reference line according to a kind of the printing medium in a second operation mode.

The first operation mode may include a single-sided printing mode of the printing medium, and the second operation mode may include a double-sided printing mode of a printing medium.

The printing medium supplying apparatus may include the printing medium aligning apparatus to guide a printing medium to form the first reference line and the second reference line in the first operation mode and the second operation mode.

The printing medium aligning apparatus may be formed to vary a position of the second reference line according to the kind of the printing medium.

The printing medium supplying apparatus may include at least one pick-up roller configured to sequentially supply the stacked printing media to the development apparatus such that centers thereof pass through the first reference line.

The image forming apparatus may further include a double-sided printing apparatus to align a side surface of the printing medium to a fixed side reference line spaced apart from the first reference line and to supply the printing medium to the development apparatus to form an image on a rear surface of the printing medium having one surface on which an image is formed in the development apparatus.

The double-sided printing apparatus may include a skew unit configured to diagonally move the printing medium along the side reference line such that the side surface of the printing medium is aligned to the side reference line.

The skew unit may include an aligning roller provided to be inclined toward the side reference line at a predetermined angle such that the printing medium is moved diagonally with respect to a progress direction.

Provided that a distance between the aligning roller and the first reference line is D, when a width (W) of the printing medium is smaller than 2 D, the printing medium aligning apparatus may vary a position of the second reference line such that a distance between the second reference line and the aligning roller becomes D.

The second reference line may be disposed between the first reference line and the side reference line.

The printing medium aligning apparatus may include a pinion member provided to be rotatable about the first reference line; a pair of rack gear members interlocked with the pinion member to be adjusted according to the width of the printing medium; and a pair of guide sections provided at the pair of rack gear members to guide both ends of the printing medium to form the first reference line or the second reference line.

Any one of the pair of guide sections is provided to be relatively movable with respect to the other guide section in a first direction away from or toward the first reference line.

The pair of guide sections may include a stationary guide unit fixed to any one of the pair of rack gear members to guide one end of the printing medium; and a variable guide unit provided at the other rack gear member to be movable in the first direction to guide the other end of the printing medium.

The variable guide unit may include a fixing member provided to be fixed to the other rack gear member, and the other rack gear member may include a plurality of coupling grooves provided to vary a position to which the fixing member is fixed according to the kind of the printing medium.

In an aspect of one or more embodiments, there is provided a printing medium supplying apparatus to supply a printing medium into an image forming apparatus having a development apparatus, the printing medium supplying apparatus including a printing medium aligning apparatus which aligns the printing medium such that a center of the printing medium passes through a first reference line in a first printing mode, wherein the printing medium aligns apparatus aligning the printing medium such that the center of the printing medium coincides with the first reference line or passes through a second reference line spaced apart from the first reference line in a second printing mode.

The first printing mode may include a single-sided printing mode of a printing medium, and the second printing mode may include a double-sided printing mode of a printing medium.

The printing medium aligning apparatus may include a stationary guide unit configured to guide one end of the printing medium; and a variable guide unit provided to independently operate with respect to the stationary guide unit and configured to form the first reference line or the second reference line with the stationary guide unit.

In an aspect of one or more embodiments, there is provided an image forming apparatus comprising: a printing medium supplying apparatus provided with a printing medium aligning apparatus; and a development apparatus configured to receive a printing medium from the printing medium supplying apparatus and form an image, wherein the printing medium aligning apparatus comprises: a pinion member; a pair of rack gear members interlocked with the pinion member to be adjusted according to a width of the printing medium; a pair of guide sections fixed to the pair of rack gear members to operate according to the operation of the pair of rack gear members; and an auxiliary aligning apparatus positioned at any one of the pair of rack gear members, wherein the pair of guide sections move with the same displacement from a first reference line according to the operation of the pair of rack gear members, wherein the auxiliary aligning apparatus supports one side surface of the printing medium and forms a second reference line between any one of the pair of rack gear members and the auxiliary aligning apparatus, and wherein the auxiliary aligning apparatus is movable in a direction toward or away from any one of the pair of rack gear members to vary a position of the second reference line, so that the printing medium aligning apparatus coincides with the first reference line or the auxiliary aligning apparatus forms the second reference line spaced apart from the first reference.

### BRIEF DESCRIPTION OF THE DRAWINGS

These and/or other aspects will become apparent and more readily appreciated from the following description of embodiments, taken in conjunction with the accompanying drawings of which:

FIG. 1 is a cross-sectional view of an image forming apparatus according to an embodiment;

FIG. 2 is a perspective view of a printing medium supplying apparatus and a double-sided printing apparatus according to an embodiment;

FIG. 3 is an exploded perspective view of the printing medium supplying apparatus and the double-sided printing apparatus according to an embodiment;

FIG. 4 is an exploded perspective view of the double-sided printing apparatus according to an embodiment;

FIG. 5 is a cross-sectional view of the printing medium supplying apparatus and the double-sided printing apparatus according to an embodiment;

FIG. 6A is a plan view of the printing medium supplying apparatus according to an embodiment when a printing medium S1 is supplied;

FIG. 6B is a plan view of the double-sided printing apparatus according to an embodiment when the printing medium S1 is supplied;

FIG. 7A is a plan view of the printing medium supplying apparatus according to an embodiment when a printing medium S2 is supplied;

FIG. 7B is a plan view of the double-sided printing apparatus according to an embodiment when the printing medium S2 is supplied;

FIG. 8 is a perspective view of the printing medium aligning apparatus according an embodiment;

FIG. 9 is an exploded perspective view of the printing medium aligning apparatus according to an embodiment;

FIG. 10 is a perspective view of a partial configuration of the printing medium aligning apparatus according to an embodiment;

FIG. 11 is a view showing movement of a variable guide unit according to an embodiment;

FIGS. 12A, 12B, and 12C are views showing an operation of the printing medium aligning apparatus according to an embodiment;

FIG. 13 is a perspective view of a printing medium aligning apparatus according to an embodiment;

FIG. 14 is a plan view of the printing medium aligning apparatus according to an embodiment;

FIG. 15 is a perspective view of a printing medium aligning apparatus according to an embodiment; and

FIG. 16 is a plan view of the printing medium aligning apparatus according to an embodiment.

### DETAILED DESCRIPTION

Reference will now be made in detail to embodiments, examples of which are illustrated in the accompanying drawings, wherein like reference numerals refer to like elements throughout.

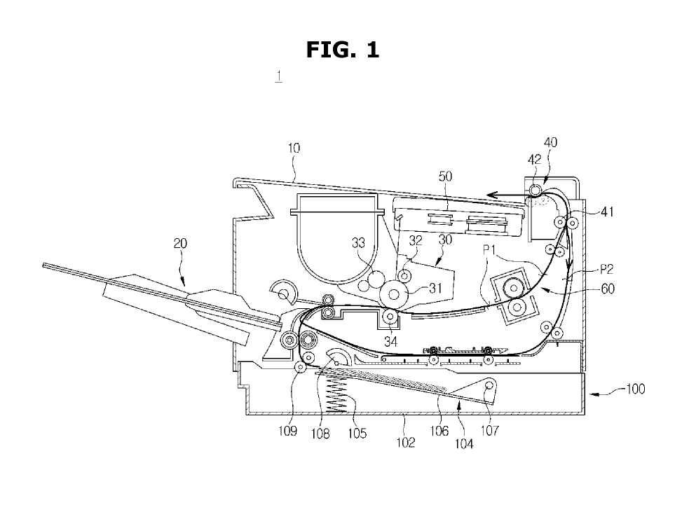

FIG. 1 is a cross-sectional view of an image forming apparatus according to an embodiment.

As shown in FIG. 1, an image forming apparatus 1 includes a main body 10, a printing medium supplying apparatus 100, a development apparatus 30, a paper discharge apparatus 40, a double-sided printing apparatus 140 and a fusing apparatus 60.

The printing medium supplying apparatus 100 supplies a printing medium S to the development apparatus 30. The printing medium supplying apparatus 100 includes a tray 20 in which the printing media S are stacked, a pick-up roller 108 configured to sequentially pick up the printing media stacked in the tray 20 one by one, and a conveyance roller 109 configured to convey the picked printing medium toward the development apparatus 30.

The development apparatus 30 develops an image on the printing medium conveyed from the printing medium supplying apparatus 100. The development apparatus 30 includes a photosensitive material 31 having a surface on which an electrostatic latent image is formed by a light scanning apparatus 50, a charge roller 32 configured to charge the photosensitive material 31, a development roller 33 configured to develop an electrostatic latent image formed on the photosensitive material 31 as a toner image, and a transfer roller 34 configured to press the printing medium toward the photosensitive material 31 such that the toner image of the photosensitive material 31 is transferred to the printing medium.

The fusing apparatus 60 applies heat and pressure to the printing medium to fix the toner image on the printing medium. A fusing roller is provided at the fusing apparatus 60 to apply the heat and pressure to the printing medium passing through the fusing apparatus 60 to fix the toner image formed on the printing medium to the printing medium.

The paper discharge apparatus 40 includes a first paper discharge roller 41 and a second paper discharge roller 42, which are sequentially installed, to discharge the printing medium passing through the fusing apparatus 60 to the outside of the main body 10.

The double-sided printing apparatus 140 conveys the printing medium, one surface of which is printed, to the upstream of the development apparatus 30 such that both surfaces of the printing medium can be printed. The double-sided printing apparatus 140 includes a double-sided printing tray 142 configured to form a double-sided printing path P2, and a series of double-sided printing rollers 160 installed on the double-sided printing path P2 to convey the printing medium. Upon double-sided printing, the printing medium, one surface of which is printed, is discharged by the second paper discharge roller 42 and inverted at a certain point to be conveyed to the double-sided printing path P2, and conveyed to the development apparatus 30 again by the double-sided printing rollers 160 to sequentially pass through the development apparatus 30 and the fusing apparatus 60 to print an image on the other surface.

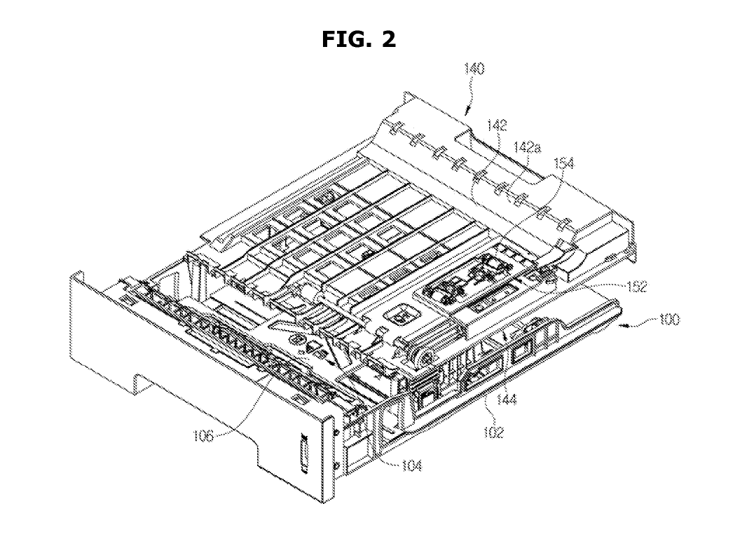

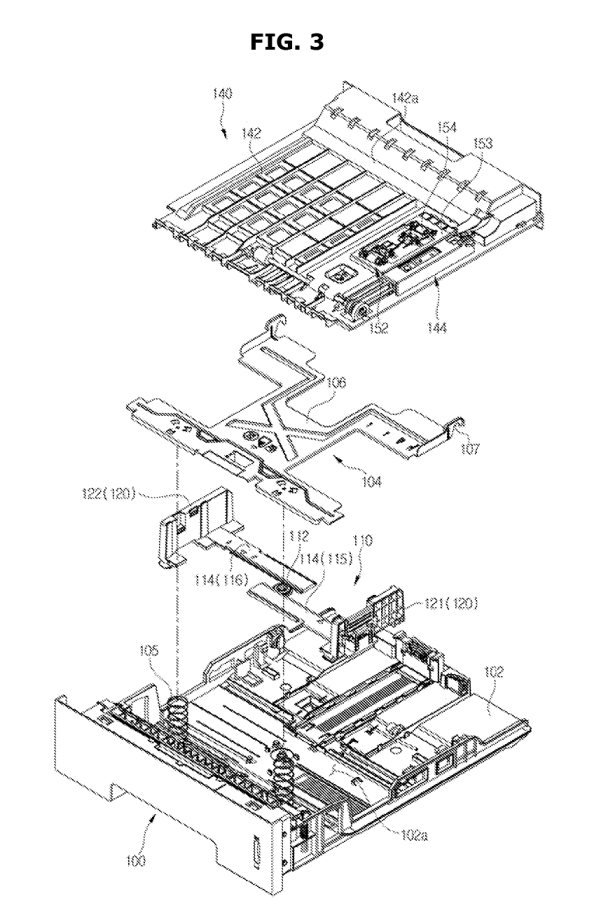

FIG. 2 is a perspective view of the printing medium supplying apparatus and the double-sided printing apparatus according to an embodiment, and FIG. 3 is an exploded perspective view of the printing medium supplying apparatus and the double-sided printing apparatus according to an embodiment.

The printing medium supplying apparatus 100 is provided to supply the printing medium S to the development apparatus in the image forming apparatus.

The printing medium supplying apparatus 100 may include a tray 102, a knock-up plate 104, the conveyance roller 109 and a printing medium aligning apparatus 110.

The tray 102 is detachably provided at the main body 10 such that the printing media S can be stacked. A stacking space 102a in which the printing media S are stacked is formed in the tray 102. In an embodiment, while the tray 102 is provided in a cassette type, the tray 102 may be provided in a type 20 in which a rotary shaft is provided at a side surface of the main body 10 such that the tray 102 can be opened and closed. In an embodiment, the tray 102 is provided to be opened at its upper side, and the printing medium S is supplied through the open section. The conveyance roller 109 may be provided at the tray 102 at the downstream of the knock-up plate 104 (to be described below) in the moving direction of the printing medium S. The at least one conveyance roller 109 is provided such that the printing medium S picked up by the pick-up roller 108 at the knock-up plate 104 is supplied to the development apparatus.

The knock-up plate 104 may be provided at the tray 102. The knock-up plate 104 is provided to be elevated with respect to the tray 102 such that the printing media S stacked in the tray 102 can be pressed toward the pick-up roller 108. Specifically, the knock-up plate 104 may be provided at the downstream in a direction in which the printing media S are supplied from the tray 102 such that the stacked printing media S are raised to be pressed toward the pick-up roller 108.

An elastic plate member 105 may be provided between the tray 102 and the knock-up plate 104 to elevate the knock-up plate 104.

The knock-up plate 104 may include a plate body 106 on which the printing media S are stacked, and a plate pivoting section 107 configured to pivot the plate body 106. The plate pivoting section 107 is provided at one side of the plate body 106, and the other side of the plate body 106 is elevated by the elastic plate member 105 to elevate the printing medium S.

The pick-up roller 108 may be disposed on a front end of the printing media S stacked in the supply tray. The uppermost printing medium S of the printing media S stacked in the supply tray is picked up one by one through rotation of the pick-up roller 108. The printing medium S picked up by the pick-up roller 108 is conveyed through the at least one conveyance roller 109 to be supplied to the development apparatus.

The pick-up roller 108 may be disposed at a center of the printing medium supplying apparatus 100 such that a center of the printing medium S passes in a progress direction of the printing medium S. When the plurality of pick-up rollers 108 are provided, the center of the printing medium S may be provided to pass through the center of the printing medium supplying apparatus 100. Since the center of the printing medium S is picked up to be supplied through the above-mentioned configuration, the supply of the printing medium S to the development apparatus becomes possible without a separate additional configuration even when the kind of the printing medium S is different.

The printing medium supplying apparatus 100 may include the printing medium aligning apparatus 110.

The printing medium aligning apparatus 110 is provided to guide the printing media S stacked in the tray 102. The printing medium S may be provided such that the center thereof is supplied along a first reference line C1 and a second reference line C2 spaced apart from the first reference line C1 according to an operation mode of the image forming apparatus. The first reference line C1 is an imaginary line provided to pass through a center of at least one pick-up roller 108 or at least one conveyance roller. Since the first reference line C1 is configured to pass through the center of the printing medium S by the pick-up roller 108 or the conveyance roller, the first reference line C1 may be defined as a fixed imaginary line. Detailed description thereof will be given.

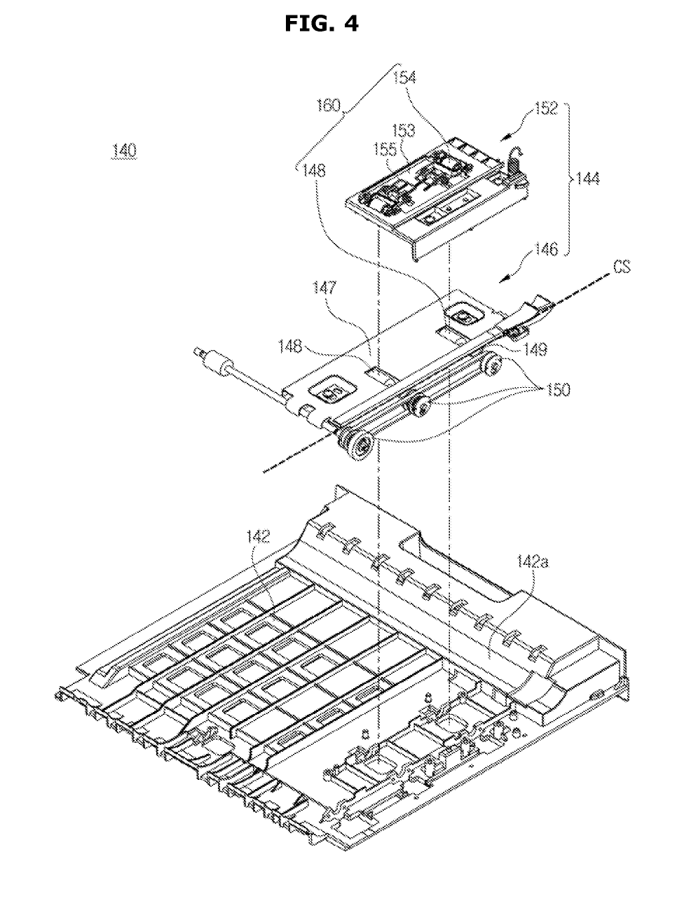

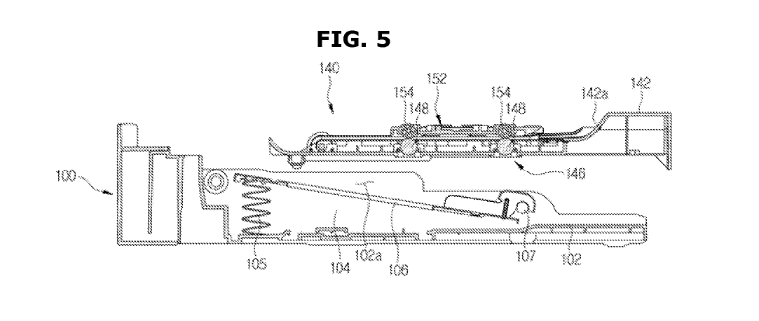

FIG. 4 is an exploded perspective view of the double-sided printing apparatus according to an embodiment, and FIG. 5 is a cross-sectional view of the printing medium supplying apparatus and the double-sided printing apparatus according to an embodiment.

The double-sided printing apparatus 140 conveys the printing medium S, one surface of which is printed, to the upstream of the development apparatus 30 again such that both surfaces of the printing medium S can be printed. The double-sided printing apparatus 140 forms the double-sided printing path P2. Upon the double-sided printing, the printing medium S, one surface of which is printed, is discharged by the second paper discharge roller and inverted at a certain point to be conveyed to the double-sided printing path P2, and conveyed to the development apparatus 30 again by the double-sided printing rollers 160 to sequentially pass through the development apparatus 30 and the fusing apparatus 60 such that the other surface is printed.

The double-sided printing apparatus 140 includes the double-sided printing tray 142 and a double-sided printing aligning apparatus 144.

The double-sided printing tray 142 is provided such that the printing medium S, one surface of which is printed, is guided to be conveyed to the development apparatus again by the development apparatus 30. Disposition of the double-sided printing tray 142 is not limited as long as the double-sided printing tray 142 is disposed on the double-sided printing path P2 such that the printing medium S, one surface of which is printed, is conveyed again to be supplied to the development apparatus 30. A double-sided printing guide surface 142a that forms the double-sided printing path P2 is formed at the double-sided printing tray 142.

The double-sided printing aligning apparatus 144 is provided to align the printing medium S passing through the double-sided printing tray 142. The double-sided printing aligning apparatus 144 includes a feeding unit 146 and a skew unit 152.

The feeding unit 146 guides movement of the printing medium S such that the printing medium S having one surface on which an image is formed is moved in the development unit. The feeding unit 146 is provided at an upper section of the double-sided printing tray 142 to guide movement of the printing medium S passing through the upper section of the double-sided printing tray 142. A feeding roller 148 is provided at the feeding unit 146 to guide movement of the printing medium S. The number of feeding rollers 148 is not limited, and in an embodiment, two feeding rollers are disposed in the progress direction of the printing medium S to be spaced apart from each other.

The feeding unit 146 includes a feeding unit body 147 disposed parallel to the double-sided printing tray 142, the at least one feeding roller 148 configured to move the printing medium S on the feeding unit body 147, at least one rotary shaft 149 provided at a rotational center of the at least one feeding roller 148, and at least one pulley 150 disposed between the feeding roller 148 and the rotary shaft 149. In an embodiment, since the plurality of feeding rollers 148 are provided, the plurality of rotary shafts 149 and the plurality of pulleys 150 are provided.

The plurality of pulleys 150 are connected by a belt, and a driving motor (not shown) is connected to the pulley 150 by a belt. The driving motor (not shown) may be directly axially coupled to any one of the plurality of pulleys 150 or may be indirectly connected to transmit power.

The skew unit 152 is provided to prevent the printing medium S from being twisted and align the printing medium S. The skew unit 152 may be provided at an upper section of the feeding unit 146.

The side reference line CS to which the printing medium S is aligned is provided at the double-sided printing tray 142, and the skew unit 152 is provided such that one side surface of the printing medium S, one surface of which is printed, is aligned to the side reference line CS and inclined with respect to the progress direction of the printing medium S. That is, the skew unit 152 may be provided to diagonally move the printing medium S such that the printing medium S is aligned to the side reference line CS.

The skew unit 152 may include a skew unit body 153 and at least one aligning roller 154 rotatably provided on the skew unit body 153. The at least one aligning roller 154 is disposed at upper and lower sides of the at least one feeding roller 148 such that the printing medium S can move between the aligning roller 154 and the feeding roller 148. That is, the double-sided printing path is formed to pass between the feeding roller 148 and the aligning roller 154.

The aligning roller 154 is provided such that an elastic compressive force is applied toward the feeding roller 148 by an elastic compressive member 155. The elastic compressive member 155 facilitates movement of the printing media S having different thicknesses by adjusting a compressive force of the aligning roller 154 according to the thicknesses of the printing medium S. The at least one aligning roller 154 is provided to be inclined at a predetermined angle such that the printing medium can move toward the side reference line CS diagonally with respect to the progress direction of the printing medium S.

The feeding roller 148 of the feeding unit 146 and the aligning roller 154 of the skew unit 152 may be generally referred to as a double-sided printing roller.

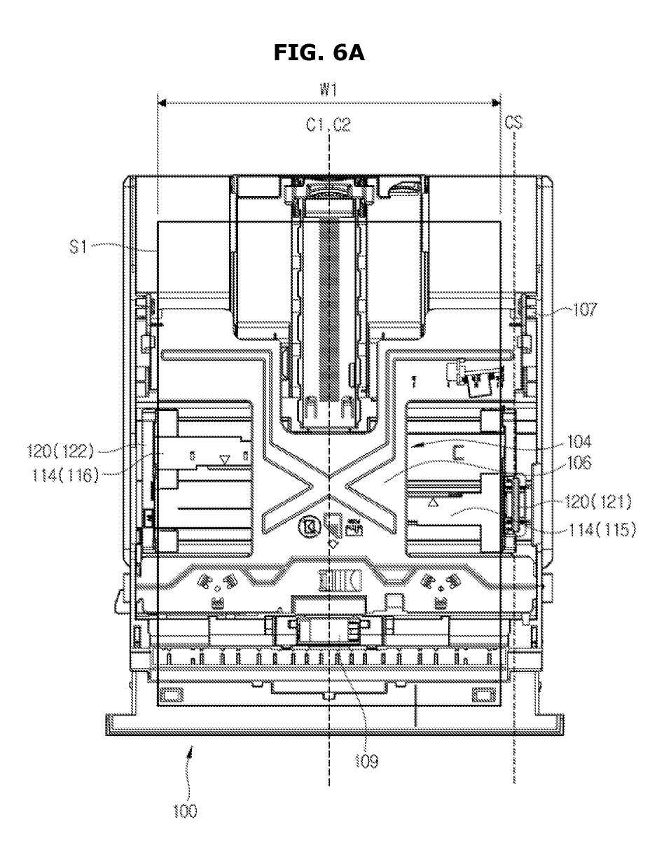

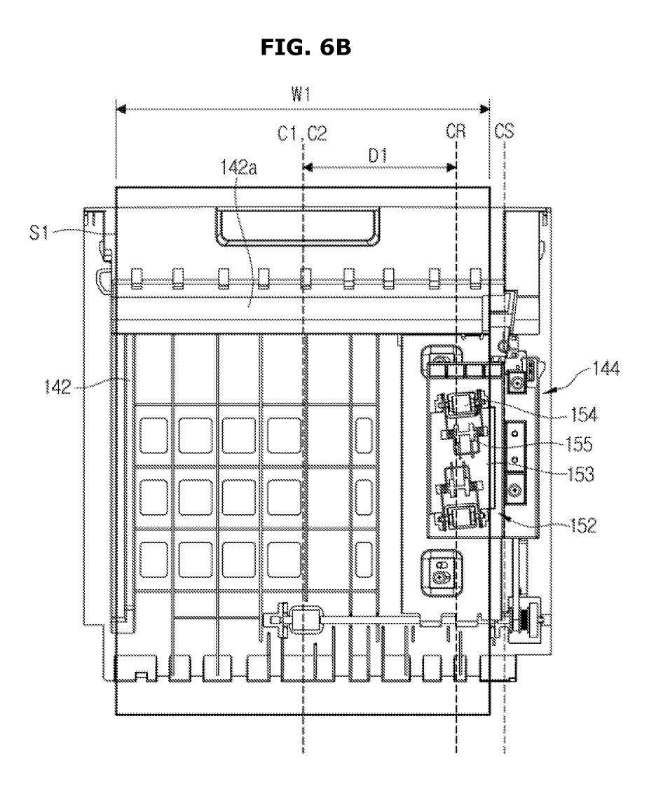

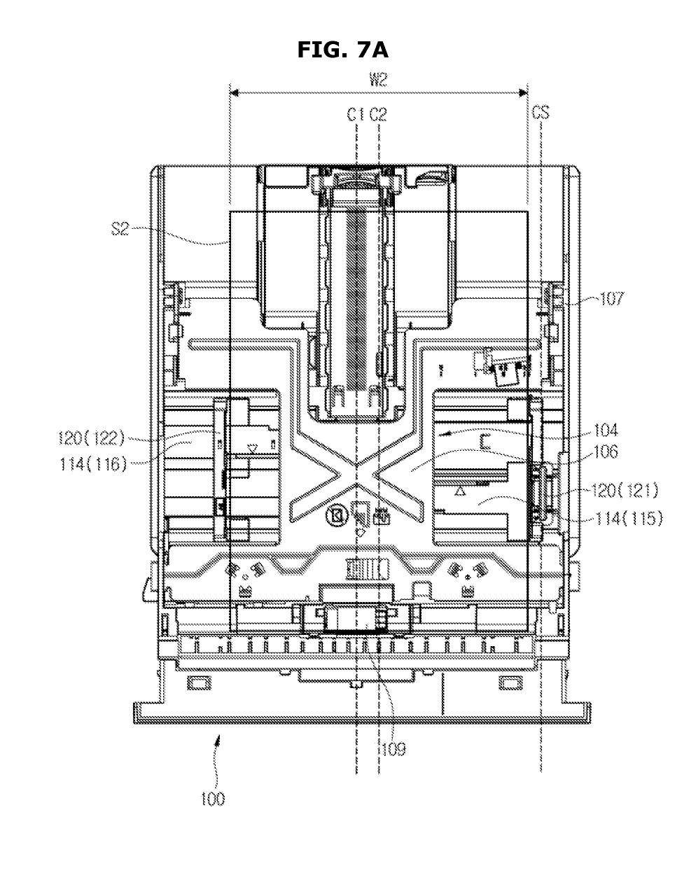

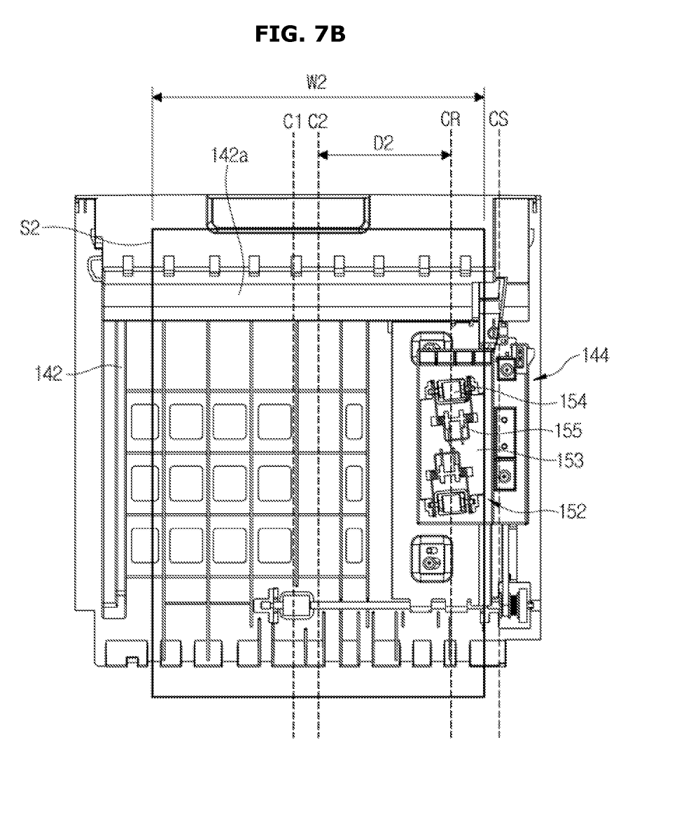

FIG. 6A is a plan view of the printing medium supplying apparatus according to an embodiment when a printing medium S1 is supplied, FIG. 6B is a plan view of the double-sided printing apparatus according to an embodiment when the printing medium S1 is supplied, FIG. 7A is a plan view of the printing medium supplying apparatus according to an embodiment when a printing medium S2 is supplied, and FIG. 7B is a plan view of the double-sided printing apparatus according to an embodiment when the printing medium S2 is supplied.

The image forming apparatus can operate a single-sided printing mode in which an image is formed on only one surface of the printing medium S, and a double-sided printing mode in which images are formed on both surfaces of the printing medium S. In the single-sided printing mode, the printing medium S is supplied from the printing medium supplying apparatus 100, and an image is formed on only one surface of the printing medium S through the development apparatus. That is, an image is formed on one surface of the printing medium S while the printing medium S passes through a single-sided printing path P1.

In the double-sided printing mode, the printing medium S supplied from the printing medium supplying apparatus 100, an image is formed on one surface of the printing medium S through the development apparatus, and then, the printing medium S is guided through double-sided printing apparatus 140 to pass through the development apparatus 30 again such that an image is also formed on a rear surface of the printing medium S. That is, images are formed on both surfaces of the printing medium S while the printing medium S while passes through the double-sided printing path P2.

In the single-sided printing mode, the printing media S stacked in the tray 102 are provided such that centers thereof move along the first reference line C1 passing through the center of the at least one pick-up roller 108 or the at least one conveyance roller 109.

In the double-sided printing mode, a side surface of the printing medium S supplied along the first reference line C1 is aligned to the side reference line CS at the double-sided printing apparatus 140. However, when the printing medium S has a small width, the printing medium S is not guided by the double-sided printing aligning apparatus 144, and thus, the image formed thereon may be skewed.

The printing medium aligning apparatus 110 is provided such that the center of the printing medium S coincides with the first reference line C1 or guided along the second reference line C2 disposed between the first reference line C1 and the side reference line CS according to the kind of the printing medium S upon the double-sided printing mode. That is, the printing medium aligning apparatus 110 can align a position of the printing medium S such that the center of the printing medium S is supplied along the first reference line C1 during the single-sided printing mode, and the center of the printing medium S coincides with the first reference line C1 or supplied along the second reference line C2 spaced apart from the first reference line C1 during the double-sided printing mode. The second reference line C2 may be formed such that a position of the printing medium S can be varied according to the kind of the printing medium S through manipulation of the printing medium aligning apparatus 110. The single-sided printing mode may be referred to as a first operation mode and the double-sided printing mode may be referred to as a second operation mode.

Provided that a distance between an imaginary line CR passing through the aligning roller 154 or the aligning roller 154 and the first reference line C1 is D, when a width W of the printing medium S is smaller than 2 D, the printing medium aligning apparatus 110 can vary a position of the second reference line C2 such that a distance from the second reference line C2 to the imaginary line CR passing through the aligning roller 154 or the aligning roller 154 becomes D. As the position of the second reference line C2 to bias the center of the printing medium S toward the side reference line CS, it is possible to prevent the printing medium S from being skewed by the double-sided printing aligning apparatus 144 of the double-sided printing apparatus 140 due to the small width of the printing medium S.

In FIGS. 6A and 6B, in the case in which a width W of the printing medium S1 is larger than 2 D, when the printing medium S1 passes through the double-sided printing apparatus 140 without adjustment of the second reference line C2, a side surface of the printing medium S1 is aligned to the side reference line CS by the aligning roller 154. Accordingly, the printing medium aligning apparatus 110 aligns the printing medium S1 to coincide the second reference line C2 with the first reference line C1.

In FIGS. 7A and 7B, in the case in which a width W of the printing medium S2 is smaller than 2 D, if there is no adjustment of the second reference line C2, when the printing medium S2 passes through the double-sided printing apparatus 140, no influence is applied to the aligning roller 154 and thus the side surface of the printing medium S2 is not aligned to the side reference line CS. That is, the double-sided printing of the printing medium S2 is not performed.

Accordingly, as a variable guide unit 122 is moved to pass through the aligning roller 154 while passing through the double-sided printing apparatus, the position of the second reference line C2 is varied. That is, the printing medium aligning apparatus 110 moves the variable guide unit 122 such that the second reference line C2 is spaced apart from the first reference line C1. As a result, the side surface of the printing medium S2 supplied along the second reference line C2 is aligned to the side reference line CS by the aligning roller 154 in the double-sided printing apparatus 140. The double-sided printing of the printing medium S2 is performed through the above-mentioned processes.

In other words, the double-sided printing becomes possible through manipulation of the printing medium aligning apparatus 110 of an embodiment regardless of variety of the kinds of the printing media S (S1, S2).

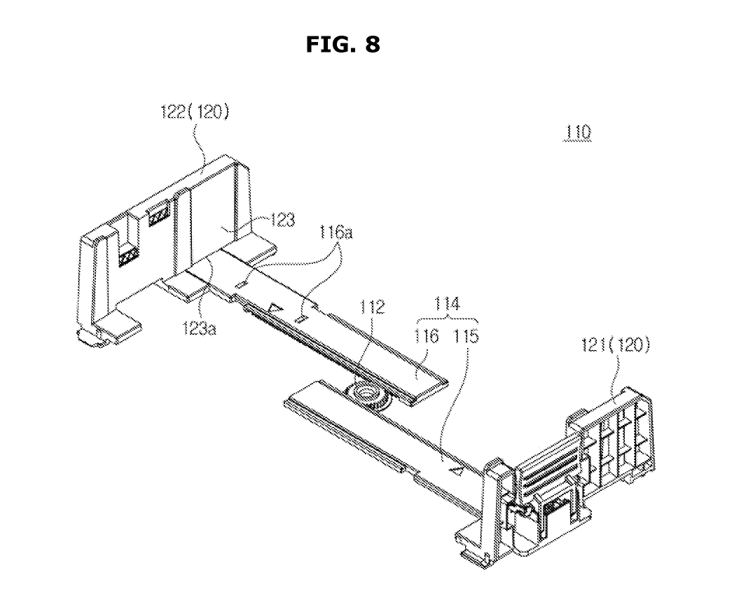

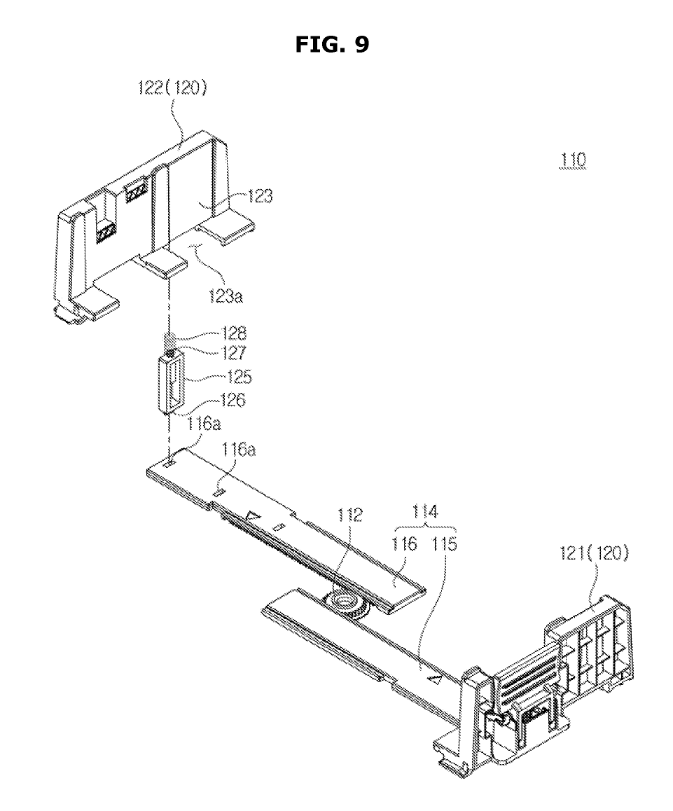

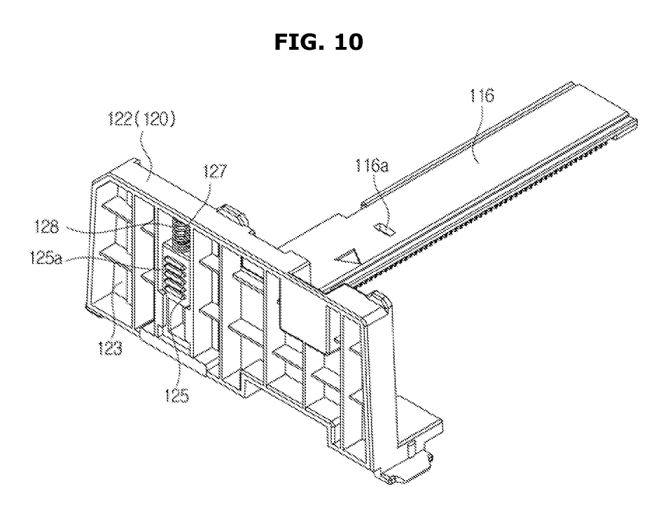

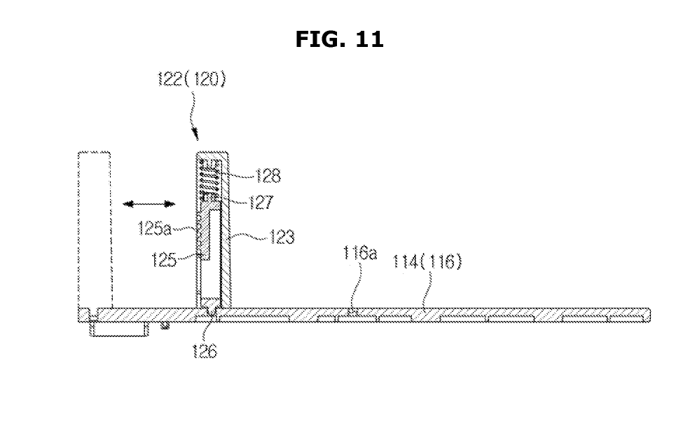

FIG. 8 is a perspective view of the printing medium aligning apparatus according to an embodiment, FIG. 9 is an exploded perspective view of the printing medium aligning apparatus according an embodiment, FIG. 10 is a perspective view of a partial configuration of the printing medium aligning apparatus according to an embodiment, and FIG. 11 is a view showing movement of the variable guide unit according to an embodiment.

The printing medium supplying apparatus 100 may include the printing medium aligning apparatus 110.

The printing medium aligning apparatus 110 includes a pinion member 112, a rack gear member 114 and a guide section 120.

The pinion member 112 is provided to be rotated about the first reference line C1, and the pair of rack gear members 114 are provided to advance or retreat about the pinion member 112. Any one of the pair of rack gear members 114 is disposed at one side of the pinion member 112 and the other rack gear member is disposed at the other side of the pinion member 112 to be moved in opposite directions according to rotation of the pinion member 112. Specifically, a gear provided inside the rack gear member 114 is meshed with a gear provided outside the pinion member 112, and the pair of rack gear members 114 are moved in opposite directions according to rotation of the pinion member 112.

The guide section 120 is provided at the rack gear member 114 to guide the side surface of the printing medium S. The pair of guide sections 120 are provided to guide both side surfaces of the printing medium S. The pair of guide sections 120 guides both side surfaces of the printing medium S to form the first reference line C1 or the second reference line C2 according to the single-sided printing mode or the double-sided printing mode.

The pair of guide sections 120 are provided to move in a first direction W1 away from or toward the first reference line C1. The pair of guide sections 120 may be provided to be independently movable in the first direction W1. Movement of the pair of guide sections 120 in the first direction W1 may be performed by movement of the above-mentioned rack gear member 114 or may be performed by movement of the variable guide unit 122 (to be described below).

The pair of guide sections 120 include a stationary guide unit 121 fixed to any one of the pair of rack gear members 114 to guide one end of the printing medium S, and the variable guide unit 122 movably provided at the other rack gear member 114 to guide the other end of the printing medium S. The variable guide unit 122 may be provided to be independently operated with respect to the stationary guide unit 121. That is, the variable guide unit 122 is configured to be relatively movable with respect to the stationary guide unit 121. Specifically, since the variable guide unit 122 is provided to be movable on the rack gear member 114, the variable guide unit 122 is relatively movable with respect to the stationary guide unit 121.

For the convenience of description, the rack gear member 114 at which the stationary guide unit 121 is disposed may be referred to as a stationary rack gear member 115, and the rack gear member 114 at which the variable guide unit 122 is disposed may be referred to as a variable rack gear member 116. A fixing member 124 (to be described below) is fixed to the variable rack gear member 116, and a plurality of coupling grooves 116a spaced apart from each other and disposed at different positions to which the fixing member 124 is fixed according to the kinds of printing media S are provided.

While the second reference line C2 is disposed at the same position as the first reference line C1 when the stationary guide unit 121 and the variable guide unit 122 have the same distance from the pinion member 112, the second reference line C2 is disposed to be spaced apart from the first reference line C1 when the variable guide unit 122 moves closer to the pinion member 112 than the stationary guide unit 121.

The variable guide unit 122 includes a variable guide body 123 configured to come in contact with the printing medium S, and the fixing member 124 configured to fix the variable guide body 123 to the variable rack gear member 116.

The variable guide body 123 is provided to come in contact with one side of the printing medium S to guide the one side of the printing medium S. A moving groove 123a configured to move the variable rack gear member 116 is formed at the lower section of the variable guide body 123. The moving groove 123a is provided such that the variable guide body 123 can move on the variable rack gear member 116. That is, the variable rack gear member 116 has a function of a movable rail, and is provided as a groove through which the variable rack gear member 116 passes such that the variable guide body 123 can move along the variable rack gear member 116.

The fixing member 124 is provided to resiliently support the variable guide body 123, and provided to be fixed after the position of the variable guide unit 122 is adjusted according to the kind of the printing medium S.

The fixing member 124 includes a fixing member body 125, and a coupling protrusion 126 provided at one end of the fixing member body 125 and coupled to the coupling groove 116a of the variable rack gear member 116.

The fixing member body 125 is provided to slide at the variable guide body 123 to move in a vertical direction. A manipulation surface 125a may be formed at the fixing member body 125 in a concavo-convex shape to facilitate manipulation thereof.

The variable rack gear section protrudes from the one end of the fixing member body 125 to be inserted into the coupling grooves 116a. The plurality of coupling grooves 116a may be formed according to the kind of the printing medium S, and the position of the second reference line C2 can be varied by varying the coupling groove 116a into which the coupling protrusion 126 is inserted according to the kind of the printing medium S.

The fixing member 124 includes an elastic support protrusion 127. The elastic support protrusion 127 may be disposed at the other end of the fixing member body 125 to support one end of an elastic coupling member 128 disposed between the fixing member body 125 and the variable guide unit 122. The other end of the elastic coupling member 128 is fixed to the fixing member body 125, and the coupling protrusion 126 of the fixing member 124 is provided not to be easily separated from the coupling groove 116a.

Movement of the variable guide unit 122 will be described below.

The plurality of coupling grooves 116a configured to variably set the second reference line C2 according to the kind of the printing medium S are formed at the variable rack gear member 116. For the convenience of description, positions of the variable guide unit 122 are defined as a first position serving as a position before movement, and a second position serving as a position after movement.

When an external force is applied to move the fixing member 124 of the variable guide unit 122 upward at the first position, the coupling protrusion 126 of the fixing member 124 is separated from the coupling groove 116a, and the variable guide body 123 can be freely moved in the first direction W1 along the variable rack gear member 116.

Next, the variable guide body 123 moves to the second position to correspond to the kind of the printing medium S.

When the variable guide body 123 is disposed at the second position, an external force with respect to the fixing member 124 is released. As the external force with respect to the fixing member 124 is released, the fixing member 124 is moved downward by the elastic force of the elastic coupling member 128, the coupling protrusion 126 of the fixing member 124 is inserted into the coupling groove 116a corresponding to the second position, and the variable guide body 123 is fixed to the variable rack gear member 116.

Hereinafter, an operation of the image forming apparatus according to the above-mentioned configuration will be described.

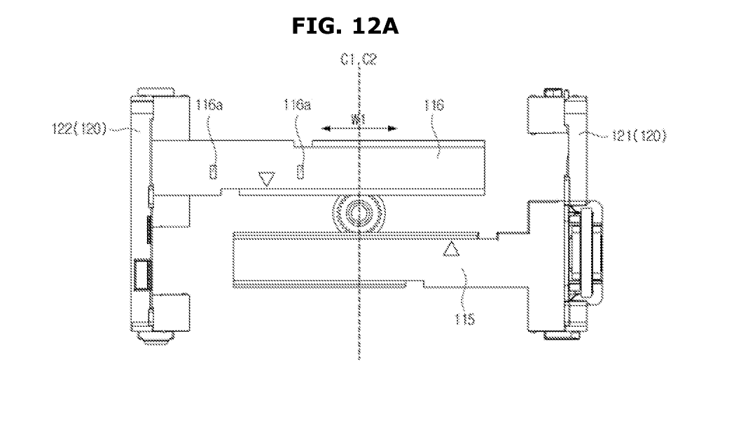

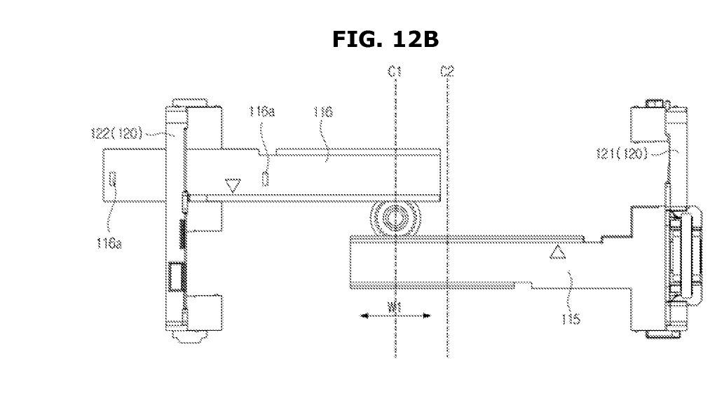

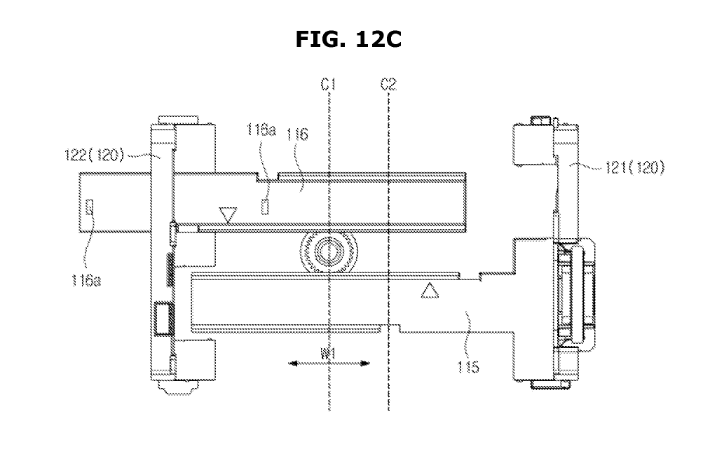

FIGS. 12A, 12B, and 12C are views showing an operation of the printing medium aligning apparatus according to an embodiment.

The operation of the printing medium aligning apparatus 110 may be divided into two types.

First, a first operation of the printing medium aligning apparatus 110 will be described.

As described above, the first operation of the printing medium aligning apparatus 110 is an operation in which the pair of rack gear member 114 advances or retreats about the first reference line C1. When the width W of the printing medium S satisfies W≧2 D with respect to the distance D between the first reference line C1 and the aligning roller 154, the second reference line C2 at which the printing medium aligning apparatus 110 is formed coincides with the first reference line C1, the center of the printing medium S is supplied along the first reference line C1.

Next, the second operation of the printing medium aligning apparatus 110 will be described.

As shown FIGS. 12A, 12B and 12C, the second operation of the printing medium aligning apparatus 110 is an operation in which the variable guide unit 122 is moved in the first direction W1 with different displacement from the stationary guide unit 121. When the width W of the printing medium S satisfies W<2 D with respect to the distance D between the first reference line C1 and the aligning roller 154, the printing medium S supplied along the first reference line C1 cannot be aligned by the double-sided printing aligning apparatus 144 upon the double-sided printing. Accordingly, the printing medium aligning apparatus 110 is manipulated as the second operation, the second reference line C2 at which the pair of guide sections 120 are formed is moved from the first reference line C1 toward the side reference line CS, and the center of the printing medium S can be biased from the first reference line C1 to be supplied.

Hereinafter, the image forming apparatus according to an embodiment will be described.

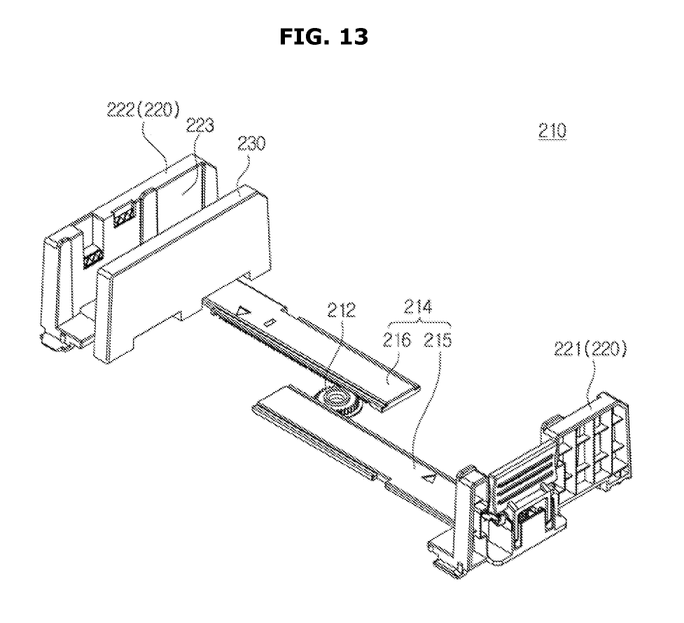

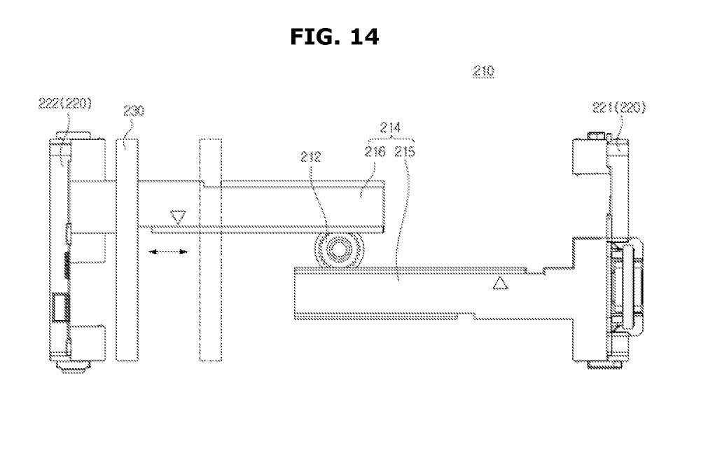

In a description of an embodiment of FIGS. 13 and 14, overlapping configurations of the description of embodiments of FIGS. 1-12 and 15-16 will be omitted.

FIG. 13 is a perspective view of the printing medium aligning apparatus according to an embodiment, and FIG. 14 is a plan view of the printing medium aligning apparatus according to an embodiment.

A configuration of a printing medium aligning apparatus 210 of the second embodiment is different from that of the first embodiment.

The printing medium aligning apparatus 210 is provided to guide the printing media S stacked on the tray 102. The printing medium S may be provided such that the center thereof is supplied along the first reference line C1 and the second reference line C2 spaced apart from the first reference line C1 according to the operation mode of the image forming apparatus. The first reference line C1 is an imaginary line provided to pass through the center of the at least one pick-up roller 108 or the at least one conveyance roller. The first reference line C1 may be defined as the fixed imaginary line since the first reference line C1 is configured to pass through the center of the printing medium S by the pick-up roller 108 or the conveyance roller.

The printing medium aligning apparatus 210 includes a pinion member 212, a pair of rack gear members 214, a pair of guide sections 220 and an auxiliary aligning apparatus.

The pinion member 212 is provided to rotate about the first reference line C1, and the pair of rack gear members 214 are provided to advance or retreat about the pinion member 212. Any one of the pair of rack gear members 214 is disposed at one side of the pinion member 212 and the other rack gear member 214 is disposed at the other side of the pinion member 212 to be moved in opposite directions according to rotation of the pinion member 212. Specifically, a gear provided inside the rack gear member 214 is meshed with a gear provided outside the pinion member 212, and the pair of rack gear members 214 are moved in opposite directions by rotation of the pinion member 212.

The guide section 220 is provided at the rack gear member 214 to guide the side surface of the printing medium S. The pair of guide sections 220 are provided to guide both side surfaces of the printing medium S, respectively. The pair of guide sections 220 guide both side surfaces of the printing medium S to form the first reference line C1 or the second reference line C2 according to the single-sided printing mode or the double-sided printing mode.

The pair of guide sections 220 are provided in the first direction W1 away from or toward the first reference line C1. Unlike the first embodiment, the pair of guide sections 220 (denoted by reference numerals 221 and 222) are fixed to the pair of rack gear members 214 (denoted by reference numerals 215 and 216), respectively, and the pair of guide sections 220 operate according to the operation of the pair of rack gear members 214. That is, the pair of guide sections 220 are provided to move with the same displacement from the first reference line C1 according to the operation of the pair of rack gear members 214.

The printing medium aligning apparatus 210 includes an auxiliary aligning apparatus 230.

The auxiliary aligning apparatus 230 is provided such that the printing medium aligning apparatus 210 coincides with the first reference line C1 or forms the second reference line C2 spaced apart from the first reference line C1 toward the side reference line CS.

The auxiliary aligning apparatus 230 is configured to support one side surface of the printing medium S, and provided to form the second reference line C2 between any one of the pair of guide sections 220 and the auxiliary aligning apparatus 230. The shape of the auxiliary aligning apparatus 230 is not limited but may have the same shape as any one of the pair of guide sections 220.

The auxiliary aligning apparatus 230 is provided to movable in the first direction W1 at any one of the pair of rack gear members 214, and thus, the position of the second reference line C2 can be varied.

Specifically, the first reference line C1 serving as a moving path of the printing medium S can be formed by the pair of guide sections 220 and the pair of rack gear members 214, and additionally, the second reference line C2 can be varied through an operation of the auxiliary aligning apparatus 230 in the first direction W1.

Hereinafter, an image forming apparatus according to an third embodiment will be described.

In description of an embodiment, overlapping configuration of the description of embodiments of FIGS. 1-14 will be omitted.

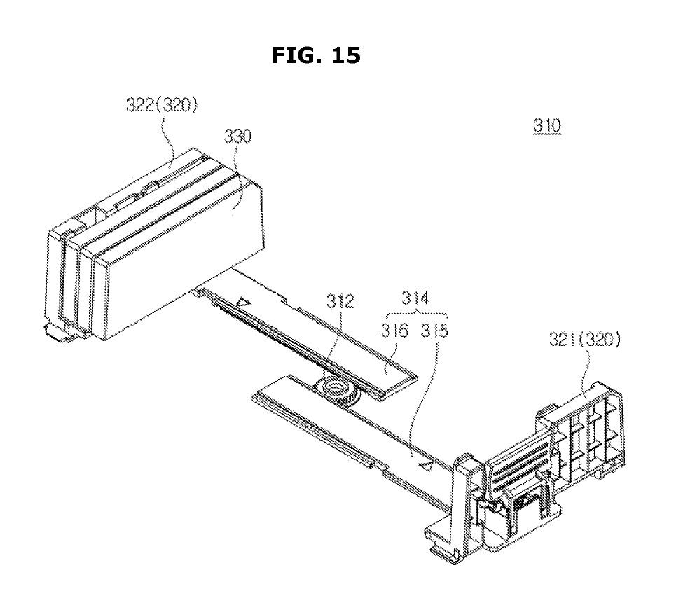

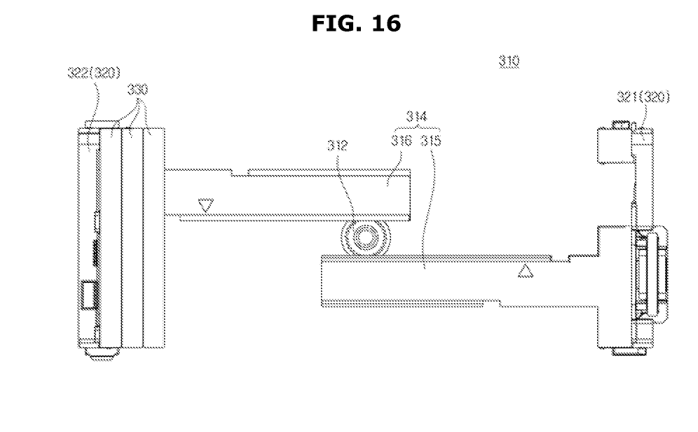

FIG. 15 is a perspective view of the printing medium aligning apparatus according to an embodiment, and FIG. 16 is a plan view of the printing medium aligning apparatus according to an embodiment.

In an embodiment of FIGS. 15 and 16, a configuration of a printing medium aligning apparatus 310 is different from that of an embodiment of FIGS. 13 and 14.

The printing medium aligning apparatus 310 includes a pinion member 312, a pair of rack gear members 314 (denoted by reference numerals 315 and 316), a pair of guide sections 320 (denoted by reference numerals 321 and 322), and an auxiliary aligning apparatus 330.

The auxiliary aligning apparatus 330 is disposed inside any one of the pair of guide sections 320 and provided to form the second reference line C2 with the other guide section 320.

The auxiliary aligning apparatus 330 is provided with a seating surface 332 to come in contact with an inner surface of any one of the pair of guide sections 320, a rear surface of the seating surface 332 is provided to come in contact with one side surface of the printing medium S, and the second reference line C2 passing through the center of the printing medium S is provided.

Since one side surface of the printing medium S is guided by the auxiliary aligning apparatus 330 seated on any one of the pair of guide sections 320 and the other side surface of the printing medium S is guided by the other guide section 320, displacement from the pinion member 312 can be varied.

As is apparent from the above description, embodiments of image forming apparatuses can improve printing efficiency through the printing medium supplying apparatus in which various kinds of printing media are compatible.

Although a few embodiments have been shown and described, it would be appreciated by those skilled in the art that changes may be made in these embodiments without departing from the principles and spirit of embodiments, the scope of which is defined in the claims and their equivalents.

What is claimed is:

1. An image forming apparatus comprising:
a printing medium supplying apparatus provided with a printing medium aligning apparatus; and
a development apparatus to receive a printing medium from the printing medium supplying apparatus and to form an image,
wherein the printing medium aligning apparatus comprises:
a stationary guide unit to guide one end of the printing medium; and
a variable guide unit to move with the stationary guide unit or independently move with respect to the stationary guide unit to guide the other end of the printing medium.

2. The image forming apparatus according to claim 1, wherein the variable guide unit is relatively movable with respect to the stationary guide unit.

3. The image forming apparatus according to claim 1, wherein the printing medium aligning apparatus comprises:
a pinion member, which is rotatably provided; and
a pair of rack gear members having a stationary rack gear member at which the stationary guide unit is disposed and a variable rack gear member at which the variable guide unit is disposed, and interlocked with the pinion member.

4. The image forming apparatus according to claim 3, wherein:
the variable guide unit comprises a fixing member provided to be fixed to the variable rack gear member, and
the variable rack gear member comprises a plurality of coupling grooves provided such that a position to which the fixing member is fixed varies according to a kind of the printing medium.

5. The image forming apparatus according to claim 1, wherein:
the printing medium supplying apparatus comprises a first operation mode and a second operation mode, and
the printing medium aligning apparatus is disposed such that centers of the stationary guide unit and the variable guide unit pass through a first reference line in the first operation mode, and such that the variable guide unit independently operates from the stationary guide unit and the centers of the variable guide unit and the stationary guide unit coincide with the first reference line or pass through a second reference line spaced apart from the first reference line in the second operation mode.

6. The image forming apparatus according to claim 5, wherein:
the first operation mode comprises a single-sided printing mode of the printing medium, and
the second operation mode comprises a double-sided printing mode of the printing medium.

7. The image forming apparatus according to claim 5, wherein the printing medium aligning apparatus is formed to vary a position of the second reference line according to a kind of the printing medium.

8. The image forming apparatus according to claim 5, wherein the printing medium supplying apparatus comprises at least one pick-up roller configured to sequentially supply the stacked printing media to the development apparatus and disposed such that the center of the printing medium passes through the first reference line.

9. The image forming apparatus according to claim 5, further comprising a double-sided printing apparatus to align a side surface of the printing medium to a side reference line spaced apart from the first reference line and to supply the printing medium to the development apparatus to form an image on a rear surface of the printing medium having one surface on which the image is formed in the development apparatus.

10. The image forming apparatus according to claim 9, wherein the double-sided printing apparatus comprises a skew unit configured to diagonally move the printing medium along the side reference line to align the side surface of the printing medium to the side reference line.

11. The image forming apparatus according to claim 10, wherein the skew unit comprises an aligning roller configured to be inclined toward the side reference line at a predetermined angle such that the printing medium is moved diagonally with respect to a progress direction.

12. The image forming apparatus according to claim 11, wherein, provided that a distance between the aligning roller and the first reference line is D, when a width (W) of the printing medium is smaller than 2 D, a position of the second reference line is varied such that a distance between the second reference line and the aligning roller becomes D.

13. The image forming apparatus according to claim 9, wherein the second reference line is disposed between the first reference line and the side reference line.

14. An image forming apparatus comprising:
a main body;
a development apparatus provided at the main body to form an image on a printing medium; and
a printing medium supplying apparatus to supply the printing medium to the development apparatus such that a center of the printing medium is supplied along a first reference line in a first operation mode, and the center of the printing medium coincides with the first reference line or is supplied along a second reference line spaced apart from the first reference line according to a kind of the printing medium in a second operation mode.

15. The image forming apparatus according to claim 14, wherein:
the first operation mode comprises a single-sided printing mode of the printing medium, and
the second operation mode comprises a double-sided printing mode of the printing medium.

16. The image forming apparatus according to claim 14, wherein the printing medium supplying apparatus comprises a printing medium aligning apparatus to guide the printing medium to form the first reference line and the second reference line in the first operation mode and the second operation mode.

17. The image forming apparatus according to claim 16, wherein the printing medium aligning apparatus is formed to vary a position of the second reference line according to the kind of the printing medium.

18. The image forming apparatus according to claim 14, wherein the printing medium supplying apparatus comprises at least one pick-up roller configured to sequentially supply the stacked printing media to the development apparatus such that centers thereof pass through the first reference line.

19. The image forming apparatus according to claim 14, further comprising a double-sided printing apparatus to align a side surface of the printing medium to a side reference line spaced apart from the first reference line and to supply the printing medium to the development apparatus to form an image on a rear surface of the printing medium having one surface on which an image is formed in the development apparatus.

20. The image forming apparatus according to claim 19, wherein the double-sided printing apparatus comprises a skew unit configured to diagonally move the printing medium along the side reference line such that the side surface of the printing medium is aligned to the side reference line.

21. The image forming apparatus according to claim 20, wherein the skew unit comprises an aligning roller provided to be inclined toward the side reference line at a predetermined angle such that the printing medium is moved diagonally with respect to a progress direction.

22. The image forming apparatus according to claim 21, wherein, provided that a distance between the aligning roller and the first reference line is D, when a width (W) of the printing medium is smaller than 2 D, the printing medium aligning apparatus varies a position of the second reference line such that a distance between the second reference line and the aligning roller becomes D.

23. The image forming apparatus according to claim 19, wherein the second reference line is disposed between the first reference line and the side reference line.

24. The image forming apparatus according to claim 16, wherein the printing medium aligning apparatus comprises:
a pinion member provided to be rotatable about the first reference line;
a pair of rack gear members interlocked with the pinion member to be adjusted according to the width of the printing medium; and
a pair of guide sections provided at the pair of rack gear members to guide both ends of the printing medium to form the first reference line or the second reference line.

25. The image forming apparatus according to claim 24, wherein any one of the pair of guide sections is provided to be relatively movable with respect to the other guide section in a first direction away from or toward the first reference line.

26. The image forming apparatus according to claim 24, wherein the pair of guide sections comprise:
a stationary guide unit fixed to any one of the pair of rack gear members to guide one end of the printing medium; and
a variable guide unit provided at the other rack gear member to be movable in the first direction to guide the other end of the printing medium.

27. The image forming apparatus according to claim 26, wherein the variable guide unit comprises a fixing member provided to be fixed to the other rack gear member, and
the other rack gear member comprises a plurality of coupling grooves provided to vary a position to which the fixing member is fixed according to the kind of the printing medium.

28. An image forming apparatus comprising:
a printing medium supplying apparatus provided with a printing medium aligning apparatus; and
a development apparatus configured to receive a printing medium from the printing medium supplying apparatus and form an image,
wherein the printing medium aligning apparatus comprises:
a pinion member;
a pair of rack gear members interlocked with the pinion member to be adjusted according to a width of the printing medium;
a pair of guide sections fixed to the pair of rack gear members to operate according to the operation of the pair of rack gear members; and
an auxiliary aligning apparatus positioned at any one of the pair of rack gear members,
wherein the pair of guide sections move with the same displacement from a first reference line according to the operation of the pair of rack gear members,
wherein the auxiliary aligning apparatus supports one side surface of the printing medium and forms a second reference line between any one of the pair of rack gear members and the auxiliary aligning apparatus, and
wherein the auxiliary aligning apparatus is movable in a direction toward or away from any one of the pair of rack gear members to vary a position of the second reference line, so that the printing medium aligning apparatus coincides with the first reference line or the auxiliary aligning apparatus forms the second reference line spaced apart from the first reference.
